(19) United States
(12) Patent Application Publication
(10) Pub. No.: US 2011/0162087 A1
(43) Pub. Date: Jun. 30, 2011

(54) VIRTUALIZING REMOTE PRESENTATION SESSION CLIENT LICENSING WITH A SERVER-BASED BROKER

(75) Inventors: Amit Lal, Krishna Nagar (IN); Rama Papa Rohini Kumar Barla, Kairathabad (IN); Ara Bernardi, Mercer Island, WA (US); Rishad Madhura Kuzhiyil, Kondapur (IN); Nelamangal Krishnaswamy Srinivas, Sammamish, WA (US); Anubhav Kushwaha, Jubilee Hills (IN)

(73) Assignee: Microsoft Corporation, Redmond, WA (US)

(21) Appl. No.: 12/651,053

(22) Filed: Dec. 31, 2009

(51) Int. Cl. G06F 15/16; G06F 21/24; G06F 9/455

(52) U.S. Cl. 726/29; 709/203; 718/1; 709/206

(57) ABSTRACT

Systems, methods, and computer-readable storage media are disclosed for virtualizing remote presentation session licensing issuance for a system executing a plurality of virtual machines hosting a remote presentation session server. In an embodiment, a licensing broker is executed in the host partition of the system, and each session server, upon receiving a request for a license from a client, transmits the request to the broker. The broker completes the license negotiation with a license server responsible for issuing licenses, and once issued, the broker transmits this to the corresponding session server, which completes the licensing transaction with the client.

### BACKGROUND OF THE INVENTION

Although computers were once isolated and had minimal or little interaction with other computers, computers now interact with a wide variety of other computers through Local Area Networks (LANs), Wide Area Networks (WANs), dial-up connections, and the like. With the wide-spread growth of the Internet, connectivity between computers has become more important and has opened up many new applications and technologies. The growth of large-scale networks, and the wide-spread availability of low-cost personal computers, has fundamentally changed the way that many people work, interact, communicate, and play.

One increasing popular form of networking may generally be referred to as remote presentation systems, which can use protocols such as Remote Desktop Protocol (RDP), Independent Computing Architecture (ICA), and others to share a desktop and other applications with a remote client. Such computing systems typically transmit the keyboard presses and mouse clicks or selections from a client computing device to a server computing device, relaying the screen updates back in the other direction over a communications network (e.g., the INTERNET™). As such, the user has the experience as if their machine is operating as part of a LAN, when in reality the client is only sent screenshots, or frames, of the applications as they appear on the server side.

Some remote presentation sessions incorporate the use of licenses. A license may determine such things as the features available in a remote presentation session (e.g. the use of a particular encoding scheme), and the number of concurrent remote presentation sessions that a server may conduct. This may be effectuated through the use of a license server. Where a client requests that a server communicate in a remote presentation session, the server may contact the license server to issue a license to the client.

In an embodiment, a server may execute a plurality of virtual machines (VMs), each VM executing remote presentation session server operations. This poses problems. The remote presentation session server and license server transaction is built on top of a trust mechanism, so now each VM must engage in its own trust mechanism with the license server. Additionally, to configure licensing and security settings requires configuring those settings for each VM serving as a remote presentation session server

### SUMMARY OF THE INVENTION

Given these problems, it would be advantageous to consolidate a portion of the licensing functions of the VMs within the physical server. In an embodiment, the server executes a broker within its host partition. This broker is responsible for implementing security and licensing configuration on the server, as well as managing the licensing transaction between the remote presentation session server of each VM and the license server.

To aid in differentiation, herein the remote presentation session server will be referred to as “session server” and the license server shall be referred to as “license server.”

This disclosure encompasses systems, methods and computer-readable storage media for implementing these teachings.

The primary embodiments described herein discuss computer-executable instructions executed by one or more processors of a computing device. However, it may be appreciated that these techniques may be implemented entirely in terms of hardware, such as through appropriately programming field-programmable gate arrays (FPGAs), or some combination thereof. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for virtualizing remote presentation session client licensing with a server-based broker are further described with reference to the accompanying drawings in which:

FIG. 1 illustrates an example general purpose computing environment in which in which the techniques described herein may be embodied.

FIG. 2 illustrates a remote presentation session involving a license.

FIG. 3 illustrates a remote presentation session involving a license, where the remote presentation server executes a plurality of VMs, each VM operating as a remote presentation server.

FIG. 4 illustrates a remote presentation session involving a license, where the remote presentation server executes a plurality of VMs, each VM operating as a remote presentation server, as well as executes a licensing broker in its host partition.

FIG. 5 illustrates an example format for a remote presentation session license to be used in a remote presentation session, such as described in FIG. 4.

FIG. 6 illustrates example operating procedures for virtualizing remote presentation session client licensing with a server-based broker.

### DETAILED DESCRIPTION OF ILLUSTRATIVE EMBODIMENTS

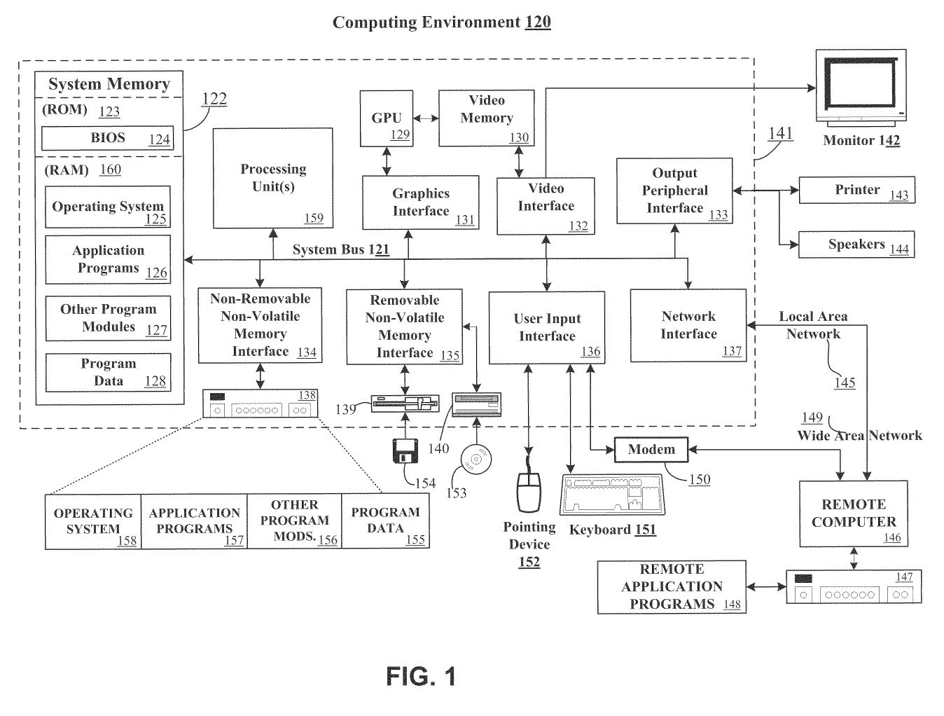

FIG. 1 is a block diagram of a general purpose computing device in which the techniques described herein may be employed. The computing system environment 120 is only one example of a suitable computing environment and is not intended to suggest any limitation as to the scope of use or functionality of the presently disclosed subject matter. Neither should the computing environment 120 be interpreted as having any dependency or requirement relating to any one or combination of components illustrated in the example operating environment 120. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 141 typically includes a variety of computer-readable media. Computer-readable media can be any available media that can be accessed by computer 141 and includes both volatile and nonvolatile media, removable and non-removable media. The system memory 122 includes computer-readable storage media in the form of volatile and/or nonvolatile memory such as read only memory (ROM) 123 and random access memory (RAM) 160. A basic input/output system 124 (BIOS), containing the basic routines that help to transfer information between elements within computer 141, such as during start-up, is typically stored in ROM 123. RAM 160 typically contains data and/or program modules that are immediately accessible to and/or presently being operated on by processing unit 159. By way of example, and not limitation, FIG. 1 illustrates operating system 125, application programs 126, other program modules 127, and program data 128.

The computer 141 may also include other removable/non-removable, volatile/nonvolatile computer storage media. By way of example only, FIG. 1 illustrates a hard disk drive 138 that reads from or writes to non-removable, nonvolatile magnetic media, a magnetic disk drive 139 that reads from or writes to a removable, nonvolatile magnetic disk 154, and an optical disk drive 140 that reads from or writes to a removable, nonvolatile optical disk 153 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 138 is typically connected to the system bus 121 through an non-removable memory interface such as interface 134, and magnetic disk drive 139 and optical disk drive 140 are typically connected to the system bus 121 by a removable memory interface, such as interface 135.

The drives and their associated computer storage media discussed above and illustrated in FIG. 1, provide storage of computer-readable instructions, data structures, program modules and other data for the computer 141. In FIG. 1, for example, hard disk drive 138 is illustrated as storing operating system 158, application programs 157, other program modules 156, and program data 155. Note that these components can either be the same as or different from operating system 125, application programs 126, other program modules 127, and program data 128. Operating system 158, application programs 157, other program modules 156, and program data 155 are given different numbers here to illustrate that, at a minimum, they are different copies. A user may enter commands and information into the computer 141 through input devices such as a keyboard 151 and pointing device 152, commonly referred to as a mouse, trackball or touch pad. Other input devices (not shown) may include a microphone, joystick, game pad, satellite dish, scanner, or the like. These and other input devices are often connected to the processing unit 159 through a user input interface 136 that is coupled to the system bus, but may be connected by other interface and bus structures, such as a parallel port, game port or a universal serial bus (USB). A monitor 142 or other type of display device is also connected to the system bus 121 via an interface, such as a video interface 132. In addition to the monitor, computers may also include other peripheral output devices such as speakers 144 and printer 143, which may be connected through a output peripheral interface 133.

The computer 141 may operate in a networked environment using logical connections to one or more remote computers, such as a remote computer 146. The remote computer 146 may be a personal computer, a server, a router, a network PC, a peer device or other common network node, and typically includes many or all of the elements described above relative to the computer 141, although only a memory storage device 147 has been illustrated in FIG. 1. The logical connections depicted in FIG. 1 include a local area network (LAN) 145 and a wide area network (WAN) 149, but may also include other networks. Such networking environments are commonplace in offices, enterprise-wide computer networks, intranets and the Internet.

When used in a LAN networking environment, the computer 141 is connected to the LAN 145 through a network interface or adapter 137. When used in a WAN networking environment, the computer 141 typically includes a modem 150 or other means for establishing communications over the WAN 149, such as the Internet. The modem 150, which may be internal or external, may be connected to the system bus 121 via the user input interface 136, or other appropriate mechanism. In a networked environment, program modules depicted relative to the computer 141, or portions thereof, may be stored in the remote memory storage device. By way of example, and not limitation, FIG. 1 illustrates remote application programs 148 as residing on memory device 147. It will be appreciated that the network connections shown are example and other means of establishing a communications link between the computers may be used.

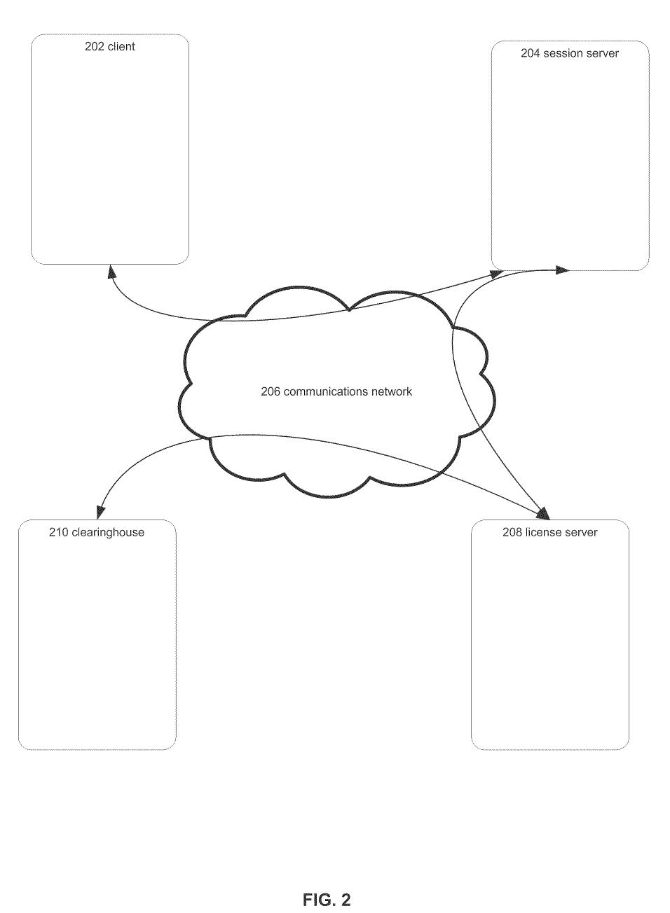

FIG. 2 illustrates a remote presentation session involving a license.

Remote presentation session licensing operates between several computing devices, including license server 208, license clearinghouse 210 (such as MICROSOFT CERTIFICATE AUTHORITY AND LICENSE CLEARINGHOUSE®), one or more session server 204s, and one or more client 202s. In an embodiment, each of these computing devices comprises computing environment 120 of FIG. 1. A single license server 208 can support multiple session server 204s. There can be one or more license server 208s in a domain, or throughout a site.

License clearinghouse 210 may be maintained by a entity that sells licenses to use in remote presentation sessions, and may be used to activate license servers and to issue client 202 license key packs to license server 208s. A client license key pack is a digital representation of a group of licenses. Licensing clearinghouse 210 may be accessed through a licensing administrative tool. It may be reached directly over a communications network 206, through a web page, or by phone.

License server 208 is a computer that stores licenses that have been installed for one or more session server 204s and tracks the licenses that have been issued. One license server 208 can serve many session server 204s simultaneously. A session server 204 must be able to connect to an activated license server 208 in order for permanent license tokens to be issued to client 202s. A license server 208 that has been installed but not activated may issue only temporary licenses.

Session server 204 is a computer with which client 202s may communicate in remote presentation sessions. It provides client 202s access to applications running entirely on the server and may support multiple client 202 sessions at the same time. As client 202s connect to session server 204, session server 204 determines whether client 202 needs a license to conduct a remote presentation session with session server 204. If client 202 does need a license, session server 204 requests a license from license server 208, and then delivers that license token to client 202.

Client 202 initiates a remote presentation session with session server 204 across communications network 206.

When client 202 attempts to connect to session server 204, session server 204 determines if client 202 has a license for a remote presentation session with server. As used in the art, a license is sometimes referred to as a “token.” In an embodiment where client 202 executes a MICROSOFT® WINDOWS® operating system, client 202 may store a license in the system registry at HKEY_LOCAL_MACHINE\Software\Microsoft\MSLicensing.

Where it is stated that client 202 needs a license to conduct a remote presentation session, it may be thought of as client 202 needing a license to continue a remote presentation, since in embodiments, client 202 and session server 204 are communicating in a remote presentation session when it is determined that client 202 needs a license.

If client 202 has no license, session server 204 attempts to contact license server 208 across communications network 206 from session server 204's list of discovered or specified license server 208s. If no contact is made, session server 204 restarts the discovery process. If no license server 208 responds, client 202 cannot conduct a remote presentation session with session server 204 unless client 202 is operating within grace period for not having a license.

When license server 208 responds, session server 204 requests a temporary license for client 202 because this is the first time client 202 has connected to session server 204. Session server 204 then sends this temporary license to client 202. After a user has provided valid credentials resulting in a successful logon, session server 204 instructs license server 208 to mark the issued temporary license as validated.

The next time client 202 attempts to connect to session server 204 in Per Device mode, session server 204 requests a license, such as a WINDOWS SERVER® 2003 TS Device client 202 access license (CAL) token, for this device. If license server 208 has an available license, license server 208 removes one token from the available pool, marks it as issued to client 202, logs an identifier of the client 202, the user name associated with the remote presentation session, and the date issued, and then pushes this license to client 202.

In an embodiment, if license server 208 has no licenses, it may first look to any other license server 208 in its domain, workgroup, or site. License server 208s may maintain information about where other accessible license server 208s exist, and if they have licenses. If another license server 208 is accessible that does have an available token, license server 208 may request a license token from this other license server 208 and deliver it to the session server 204, which then passes the token to client 202. If there are no available licenses, client 202 may continue to connect to session server 204 with the temporary token.

In an embodiment, a temporary tokens allow client 202 to connect to server for 90 days, and will then expire. TS Device CALs, while representing perpetual licenses, are set to expire 52-89 days from the date they are issued. Session server 204 may attempt to renew these tokens 7 days prior to their expiration. The purpose of this system is to recover TS Device CAL tokens that are lost due to events such as hardware failure or operating system reinstallation.

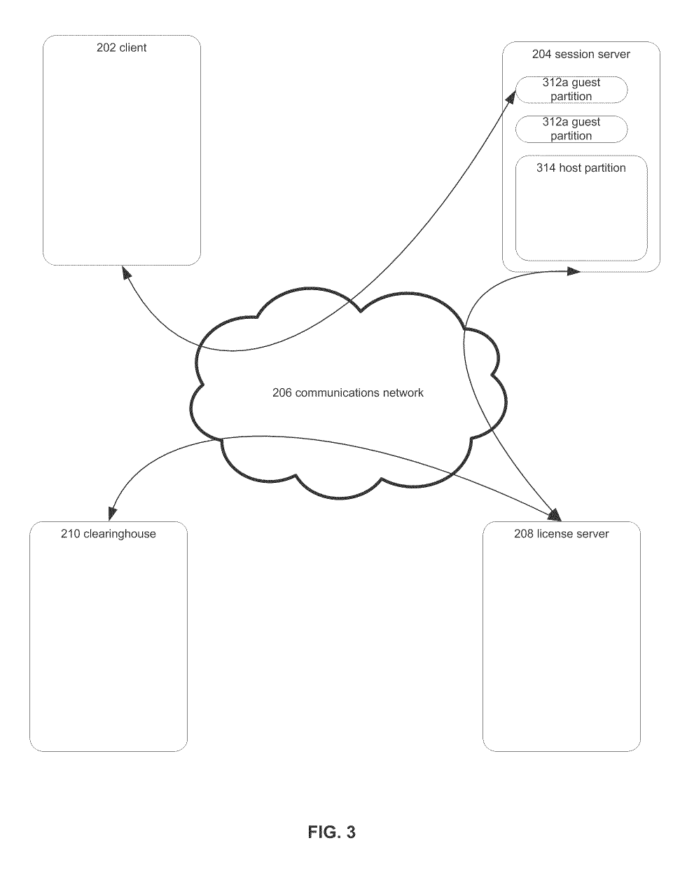

FIG. 3 illustrates a remote presentation session involving a license, where the remote presentation server executes a plurality of VMs, each VM in a guest partition 312, each VM operating as a remote presentation server.

In this embodiment, a plurality of guest partition 312s may be concurrently communicating in remote presentation sessions. It may be that a plurality of those remote presentation sessions requires the use of a license. Each guest partition 312 that needs a license may contact license server 208 for a license, as is discussed with regard to FIG. 2. Each guest partition 312 performing these operations may be considered to be functioning as a remote presentation session server. That is, session server 204 may comprise a plurality of remote presentation session servers.

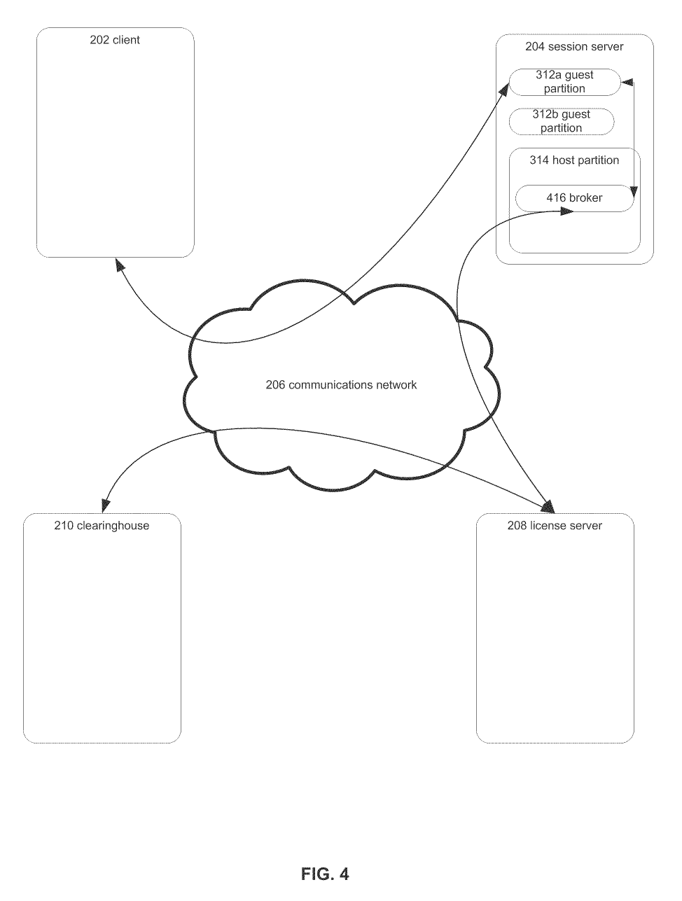

FIG. 4 illustrates a remote presentation session involving a license, where the remote presentation server executes a plurality of VMs, each VM operating as a remote presentation server, as well as executes a licensing broker 416 in its host partition 314.

In this embodiment, a plurality of guest partition 312s may be concurrently communicating in remote presentation sessions, similar to as in FIG. 3. It may be that a plurality of those remote presentation sessions requires the use of a license.

Where in the embodiment of FIG. 3, each remote presentation session server 204 executed in a guest partition 312 was responsible communicating with license server 208 to obtain a license, here each guest partition 312 communicates with broker 416 operating in host partition 314 (such as through remote procedure calls (RPCs) over a logical channel that enables inter-process communication, such as VMBus on MICROSOFT HYPER-V®). Broker 416 is responsible for implementing security (for example, a list of license servers with which broker 416 may communicate) and licensing configuration on session server 204, as well as managing the licensing transaction between the remote presentation session server 204 of each VM and the license server 208.

Where guest partition 312 determines that client 202 requires a license to continue a remote presentation session, it transmits an indication of this to broker 416. Communication between guest partition 312 and broker 416 may be conducted, for example, through remote procedure calls (RPCs). Broker 416 then completes the transaction with license server 208 and, where a license is obtained, passes this license to guest partition 312, which completes the license transaction with client 202.

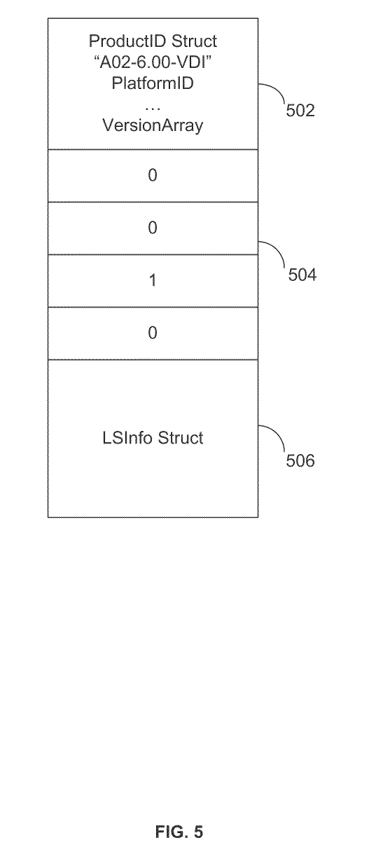

FIG. 5 illustrates an example format for a remote presentation session license to be used in a remote presentation session, such as described in FIG. 4. In embodiments, additional or fewer fields are used, depending on the particulars of a remote presentation system. In embodiments, those fields are arranged in various permutations. License header 502 may comprise information including a version of the license, the length of the license, a checksum, and/or what other fields of the license mean (such as, the significance of the first bit of feature array 504). Feature array may comprise a series of bits, each bit corresponding to a boolean value of whether a corresponding feature is enabled by the license. For instance, the first bit of the array may be set to equal “1,” which corresponds to boolean TRUE, which indicates that a particular form of compression is available in the session (“0” corresponds to boolean FALSE, which indicates that the feature is not available in the session). LSInfo Struct 506 may comprise the name of the license server that issued the license server, and a unique identifier for the license server (a “PID”).

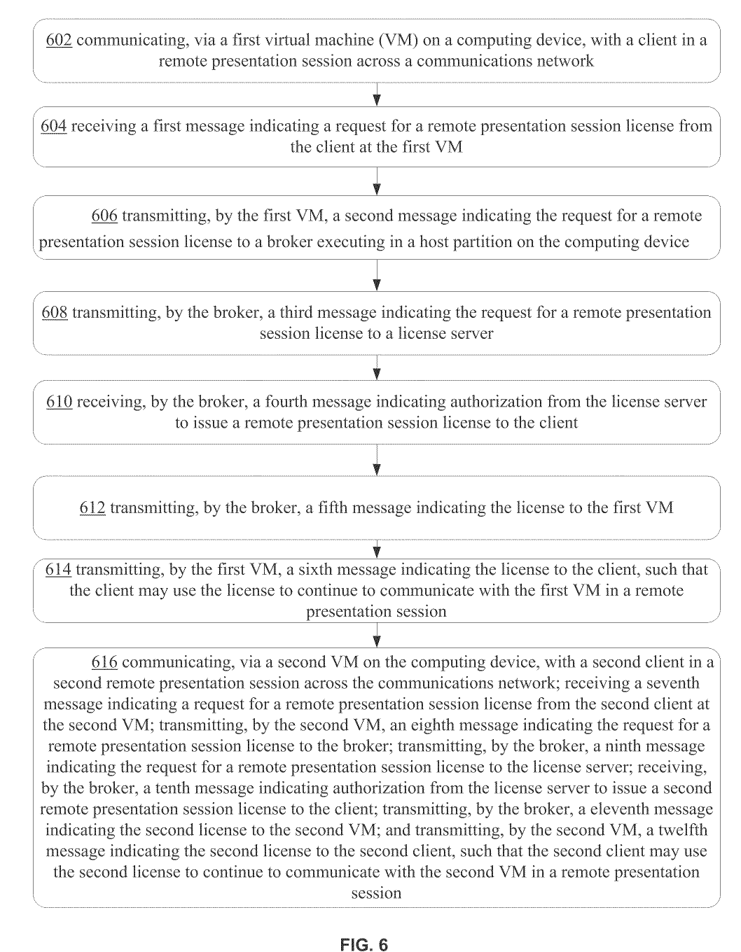

FIG. 6 illustrates example operating procedures for virtualizing remote presentation session client 202 licensing with a server-based broker 416.

Operation 602 depicts communicating, via a first virtual machine (VM) on a computing device, with a client 202 in a remote presentation session across a communications network 206.

Operation 604 depicts receiving a first message indicating a request for a remote presentation session license from the client 202 at the first VM.

In an embodiment, a license proscribes which of a set of features the client 202 may use in the remote presentation session with the server. In an embodiment, the set of features comprises an encoding scheme (e.g. Calista), and a type of remote presentation session (e.g. VDI-standard, VDI-premium, whether client may access devices connected to session server, an whether a system center virtual machine manager (SCVMM) may be used).

Operation 606 depicts transmitting, by the first VM, a second message indicating the request for a remote presentation session license to a broker 416 executing in a host partition 314 on the computing device.

Operation 608 depicts transmitting, by the broker 416, a third message indicating the request for a remote presentation session license to a license server 208.

In embodiment, the broker 416 and the license server 208 communicate via a trusted computing relationship. For example, broker 416 and license server 208 may each comprise signed computer-executable instructions, such that it can be verified that those computer-executable instructions have not been modified since being signed by comparing them to the signature. Broker 416, knowing license server 208's signature, can verify that license server 208 is in a known acceptable state and not verified, and license server 208 may perform the same operation on broker 416.

Operation 610 depicts receiving, by the broker 416, a fourth message from the license server 208 indicating a remote presentation session license to issue to the client 202. In an embodiment, licensing server 208 generates the license and sends that generated license to the broker.

In an embodiment, the fourth message comprises the license.

Operation 612 depicts transmitting, by the broker 416, a fifth message indicating the license to the first VM.

Operation 614 depicts transmitting, by the first VM, a sixth message indicating the license to the client 202, such that the client 202 may use the license to continue to communicate with the first VM in a remote presentation session.

Operation 616 depicts communicating, via a second VM on the computing device, with a second client 202 in a second remote presentation session across the communications network 206; receiving a seventh message indicating a request for a remote presentation session license from the second client 202 at the second VM; transmitting, by the second VM, an eighth message indicating the request for a remote presentation session license to the broker 416; transmitting, by the broker 416, a ninth message indicating the request for a remote presentation session license to the license server 208; receiving, by the broker 416, a tenth message indicating authorization from the license server 208 to issue a second remote presentation session license to the client 202; transmitting, by the broker 416, a eleventh message indicating the second license to the second VM; and transmitting, by the first VM, a twelfth message indicating the second license to the second client 202, such that the second client 202 may use the second license to continue to communicate with the second VM in a remote presentation session.

In an embodiment, the second license authorizes different functionality than that authorized by the first license

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating therefrom. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method, comprising:
communicating, via a first virtual machine (VM) on a computing device, with a client in a remote presentation session across a communications network;
receiving a first message indicating a request for a remote presentation session license from the client at the first VM;
transmitting, by the first VM, a second message indicating the request for a remote presentation session license to a broker executing in a host partition on the computing device;
transmitting, by the broker, a third message indicating the request for a remote presentation session license to a license server;
receiving, by the broker, a fourth message from the license server indicating a remote presentation session license to issue to the client;
transmitting, by the broker, a fifth message indicating the license to the first VM; and
transmitting, by the first VM, a sixth message indicating the license to the client, such that the client may use the license to continue to communicate with the first VM in a remote presentation session.

2. The method of claim 1, further comprising:
communicating, via a second VM on the computing device, with a second client in a second remote presentation session across the communications network;
receiving a seventh message indicating a request for a remote presentation session license from the second client at the second VM;
transmitting, by the second VM, an eighth message indicating the request for a remote presentation session license to the broker;
transmitting, by the broker, a ninth message indicating the request for a remote presentation session license to the license server;
receiving, by the broker, a tenth message indicating authorization from the license server to issue a second remote presentation session license to the client;
transmitting, by the broker, a eleventh message indicating the second license to the second VM; and
transmitting, by the second VM, a twelfth message indicating the second license to the second client, such that the second client may use the second license to continue to communicate with the second VM in a remote presentation session.

3. The method of claim 2, wherein the second license authorizes different functionality than that authorized by the license

4. The method of claim 1, wherein a license proscribes which of a set of features the client may use in the remote presentation session with the server.

5. The method of claim 4, wherein the set of features comprises an encoding scheme, and a type of remote presentation session.

6. The method of claim 1, wherein the broker and the license server communicate via a trusted computing relationship.

7. The method of claim 1, wherein the fourth message comprises the license.

8. A system, comprising:
a processor;
a memory storing instructions that, when executed on the processor, cause the processor to perform operations comprising:
communicating, via a first virtual machine (VM) on a computing device, with a client in a remote presentation session across a communications network;
receiving a first message indicating a request for a remote presentation session license from the client at the first VM;
transmitting, by the first VM, a second message indicating the request for a remote presentation session license to a broker executing in a host partition on the computing device;
transmitting, by the broker, a third message indicating the request for a remote presentation session license to a license server;
receiving, by the broker, a fourth message indicating authorization from the license server to issue a remote presentation session license to the client;
transmitting, by the broker, a fifth message indicating the license to the first VM; and
transmitting, by the first VM, a sixth message indicating the license to the client, such that the client may use the license to continue to communicate with the first VM in a remote presentation session.

9. The system of claim 8, wherein the memory further stores instructions that, when executed on the processor, cause the processor to perform operations comprising:
communicating, via a second VM on the computing device, with a second client in a second remote presentation session across the communications network;
receiving a seventh message indicating a request for a remote presentation session license from the second client at the second VM;
transmitting, by the second VM, an eighth message indicating the request for a remote presentation session license to the broker;
transmitting, by the broker, a ninth message indicating the request for a remote presentation session license to the license server;
receiving, by the broker, a tenth message indicating authorization from the license server to issue a second remote presentation session license to the client;
transmitting, by the broker, a eleventh message indicating the second license to the second VM; and
transmitting, by the first VM, a twelfth message indicating the second license to the second client, such that the second client may use the second license to continue to communicate with the first VM in a remote presentation session.

10. The system of claim 9, wherein the second license authorizes different functionality than that authorized by the license

11. The system of claim 8, wherein a license proscribes which of a set of features the client may use in the remote presentation session with the server.

12. The system of claim 11, wherein the set of features comprises an encoding scheme, and a type of remote presentation session.

13. The system of claim 8, wherein the broker and the license server communicate via a trusted computing relationship.

14. The system of claim 8, wherein the fourth message comprises the license.

15. A computer-readable storage medium bearing computer-executable instructions that, when executed on a computing device, cause the computing device to perform operations comprising:
communicating, via a first virtual machine (VM) on a computing device, with a client in a remote presentation session across a communications network;
receiving a first message indicating a request for a remote presentation session license from the client at the first VM;
transmitting, by the first VM, a second message indicating the request for a remote presentation session license to a broker executing in a host partition on the computing device;
transmitting, by the broker, a third message indicating the request for a remote presentation session license to a license server;
receiving, by the broker, a fourth message from the license server indicating a remote presentation session license to issue to the client;
transmitting, by the broker, a fifth message indicating the license to the first VM; and
transmitting, by the first VM, a sixth message indicating the license to the client, such that the client may use the license to continue to communicate with the first VM in a remote presentation session.

16. The computer-readable storage medium of claim 15, further bearing computer-executable instructions that, when executed on the computing device, cause the computing device to perform operations comprising:
communicating, via a second VM on the computing device, with a second client in a second remote presentation session across the communications network;
receiving a seventh message indicating a request for a remote presentation session license from the second client at the second VM;
transmitting, by the second VM, an eighth message indicating the request for a remote presentation session license to the broker;
transmitting, by the broker, a ninth message indicating the request for a remote presentation session license to the license server;
receiving, by the broker, a tenth message from the license server indicating a second remote presentation session license to issue to the client;
transmitting, by the broker, a eleventh message indicating the second license to the second VM; and
transmitting, by the first VM, a twelfth message indicating the second license to the second client, such that the second client may use the second license to continue to communicate with the first VM in a remote presentation session.

17. The computer-readable storage medium of claim 16, wherein the second license authorizes different functionality than that authorized by the license

18. The computer-readable storage medium of claim 15, wherein a license proscribes which of a set of features the client may use in the remote presentation session with the server.

19. The computer-readable storage medium of claim 18, wherein the set of features comprises an encoding scheme, and a type of remote presentation session.

20. The computer-readable storage medium of claim 15, wherein the broker and the license server communicate via a trusted computing relationship.
